(19) United States
(12) Patent Application Publication
(10) Pub. No.: US 2011/0153237 A1
(43) Pub. Date: Jun. 23, 2011

(54) METHOD AND APPARATUS FOR EVALUATING ENERGY SAVINGS

(76) Inventors: Arne F. Jonsson, Hagfors (SE); Thord E. Johansson, Brastad (SE)

(21) Appl. No.: 13/060,696

(22) PCT Filed: Aug. 28, 2009
(86) PCT No.: PCT/SE2009/050977

§ 371 Date: Mar. 4, 2011

(30) Foreign Application Priority Data
Aug. 29, 2008 (SE) 0801871-5

(51) Int. Cl. G06F 19/00

(52) U.S. Cl. 702/60

(57) ABSTRACT

A method for determining power and energy saving, preferably by rotation speed regulation/speed control of rotodynamic machines, i.e. primarily pumps, fans, turbo- compressors and agitators, relative to another type of regulation, where a constant rotation speed is used. Primarily, a power saving ΔP, ΔP′, ΔP″ is determined, which, after integration over time, yields an energy saving. The method is characterized in that the shaft speed n and the shaft power P1 of the machine or a power depending on the same, are measured directly or indirectly and that the required power P0, P0′, P0″ is calculated from the affinity laws. During throttle regulation with a regulating valve, a power P2 at full rotation speed is determined from, among other things, the slope of the power curve kₚ. The power saving is then constituted of ΔP=P2−P1 for throttle regulation, and ΔP′=P0′−P1 and ΔP″=P0″−P1, respectively, for some other regulating methods. Losses in prime mover as well as in rotation speed control equipment are taken into account for refining the size of the saving. The parameters required for power determination are refined from the values measured during operation according to the foregoing through a continuously adaptive method.

### TECHNICAL FIELD

The present invention relates to a method and an apparatus for determining a power and energy saving, preferably achieved by installation of rotation speed regulation/speed control in rotodynamic machines. A typical example of an application comprises an industrial process plant, which for example comprises a piping system through which a gas, liquid, suspension, or the like is conveyed. The conveyed medium is forwarded and processed by means of rotodynamic machines comprising pumps, fans, compressor, agitators, etc., which in their turn are driven by electric motors, usually of an asynchronous type.

For a given such machine, provided with rotation speed control, the method determines the actual power consumption at a certain point in time and, for comparison, a corresponding simultaneous power consumption for the same machine in the same piping system, when it has no rotation speed control installed but would then have been regulated by an imaginary/fictitious regulation of another type.

The instantaneous power saving becomes the difference between the second and the first-mentioned power consumption. At equal and constant power saving over time, the energy saving is obtained as power saving multiplied by time. For the general case, the energy saving is obtained as the integral over time of the power sawing.

### STATE OF THE ART

A large number of portable measuring equipments, so called measuring kits, for temporary determinations of volume flow, pressure and powers, are available on the market. These are primarily aimed at determining the efficiency of the machine or, in more general terms, its efficiency for the type of regulation being used during the measurement. The efficiency of the machine itself can be determined directly by a thermodynamic method, i.e. by determining the temperature increase of the medium during its passage through the machine. In certain cases, wireless transfer of certain signals, for example electrical current measured in a remotely located switchgear, is utilized. However, these measuring equipments only provide information about the required power of the machine, without any comparison being made with another technique or with another type of regulation, as is the case with the method according to the invention.

In the patent publication U.S. Pat. No. 4,208,171, there is disclosed a method for determining volume flow for a rotation speed-regulated pump, when rotation speed and certain defined pressure heads are known, so-called indirect flow measurement. This is based on characteristics in the so-called Q-H diagram, compare with FIG. 1. The indirect flow measurement is incorporated here since its nature has certain similarities with the invention. However, it provides no indication whatsoever of the required power, and thereby lacks any foundation for a required power comparison.

The document EP1548925 A1 describes a method for evaluating the energy consumption in an electric AC motor with associated control circuit, and a comparison is made between operation with and without rotation speed regulation. The energy consumption without speed regulation is calculated in a very rough way for the comparison, which results in considerable errors in the evaluation result

### SUMMARY OF THE INVENTION

The power and energy saving achieved with a rotation speed regulation compared to another type of regulation has previously been rather unreliable and difficult to judge in size because of variations in, among other things, the facility, operation, etc., which are described further below. The unreliability has meant that concrete information on the economic benefit from introducing a rotation speed control for a given machine has not been possible to determine. One purpose of the invention is to enable a determination of power and/or energy saving with such accuracy that it can form a basis for financial settlements. These can, for instance, relate to an executed installation of a rotation speed control bringing about a certain saving relative to another type of regulation, possibly being used before this installation. This saving can, in its turn, form the basis for a settlement of the financing of the rotation speed control installation, for example by means of profit sharing between a plant owner, on the one hand, who has a machine (pump etc. and an electric motor) in operation in his/her plant, and a supplier of the rotation speed control equipment, on the other hand. In certain cases, the supplier can be replaced by a third party, for example an electricity supplier or a bank, acting as a financier.

The method according to the invention is of particularly great importance in, for example the process industry, where initial investments in its core business are prioritized, whereas margin investments, for example energy saving by rotation speed control normally will not be realized. However, the profitability is so high that other types of financing, for example with profit sharing as exemplified above, are interesting.

One advantage of the invention lies in the fact that, by means of an instantaneous measurement and evaluation, a considerably greater accuracy and actuality is achieved compared to calculations based on a theoretical/ideal condition prevailing, for example, during the projecting, or compared to simple estimates performed at a certain point in time. Since the realisation of a plant, a piping system may, for example, have been changed with regard to, for example, pipe diameter, piping length, included fittings such as bends, valves, as well as piping quality in the form of welds, hanging gaskets, etc. Furthermore, also the internal condition of a pipe with deposits, corrosion damages and, for example, bright polishing of its inner surface, has an influence. At a prevailing temperature, the instantaneous characteristics of a medium (a liquid/a gas) such as density, viscosity and composition, for example consistency of paper pulp suspensions, have an influence. In liquid lines partially filled with gas or air may additional flow resistances of an unknown magnitude arise. In long pipelines, intended for fluid transportation of different liquids in the form of “plugs” with, for example, different liquid density, both the generation of pressure by a pump and the pressure loss in a pipeline will depend on the instantaneous position of the liquid plugs. The corresponding of course applies to the required power. In conventional measurements, wear in machines results in more unreliability. For conventional methods, another complication is added when a worn-out machine is reconditioned. The continuous adaptation to the actual situation, according to the invention, with associated measurements/evaluations, is of an extremely great importance during the periods a financial settlement can last for, which usually means several years.

By means of the invention, a good accuracy is obtained because only the main parameters of influence are studied and utilized for a saving determination. According to the invention, in a preferred embodiment, these are constituted of shaft rotation speed, instantaneous power at this rotation speed, the basic power curve of the machine as a function of the volume flow, and the nature and magnitude of internal losses in prime mover and rotation speed control. By means of the invention, the need for extensive measurements of volume flow, pressure heads, powers, and the characteristics of the medium are eliminated. Further aspects of and advantages with the invention are evident from the following description in connection with exemplifying embodiments according to the invention.

### BRIEF DESCRIPTION OF FIGURES

In the following, the invention will be described in greater detail with reference to the accompanying figures of embodiments according to the invention, in which

FIG. 1 shows the general relationship for pressure head H in a simple system (piping system) and for a rotodynamic machine (a pump) in dependence upon the volume flow Q.

FIG. 2 shows a simplified curve for the power P at a given constant rotation speed in dependence upon the volume flow Q.

FIGS. 3-5 show alternative system curves for regulation at a constant pressure, constant volume flow, and along an individual system curve, respectively.

FIG. 6 shows both Q-H curve as well as P-Q curve for a full relative rotation speed (n=1) and a lower relative rotation speed (n).

FIGS. 7-8 show how a rotodynamic machine, an electric motor, and a rotation speed control can be arranged with respect to each other.

### DETAILED DESCRIPTION

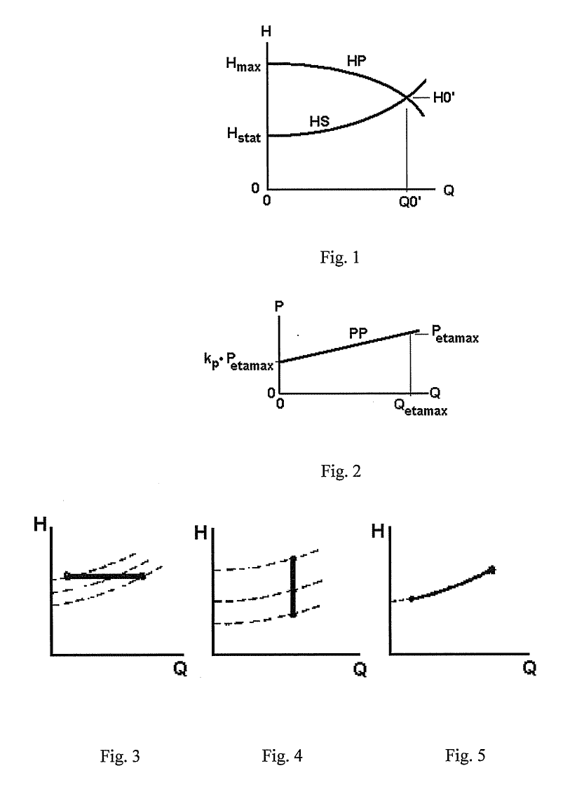

FIG. 1 shows a diagram typical of the pump industry, where H represents a pressure head and Q a volume flow. The performance of a pump is given as the curve HP and the flow resistance in a system by the curve HS, which is usually called the system curve. The intersection between these curves yields the actual volume flow, which is designated with Q0′ in the figure. The quantities Hₛₜₐₜ and Hₘₐₓ are pressure heads, generally describing the nature of the system. The ratio between them is constituted of a hydraulic system parameter k_{H}=Hₛₜₐₜ/Hₘₐₓ.

FIG. 2 shows the power curve of a pump, designated PP, as a function of the volume flow Q. At the best efficiency of the machine and/or the design point Qₑₜₐₘₐₓ, the power is Pₑₜₐₘₐₓ, and at the volume flow 0 (zero), the power is kₚ·Pₑₜₐₘₐₓ. Practically, the curve can in many cases be regarded as a straight line, as in the figure. The parameter/factor kₚ is a machine characteristic depending on a so called specific rotation speed or the corresponding in a dimensionless form of a so-called type number. For rotodynamic machines with impellers having a pronounced radial extension is kₚ=0.3-0.4, for semi-axial machines is kₚ=approx. 1, and for extremely axial impeller shapes, the curve PP has a negative slope with values within a range where kₚ=1.2 is normal. More precise values are available from manuals, and can also be determined from test data for an actual machine. The angular coefficient of the straight line is 1−kₚ. The straight line can advantageously be replaced by a curve, preferably a 3rd degree polynomial. This can be based on general values or on test data for an actual machine. For a polynomial, the derivative with respect to the volume flow within a certain range corresponds to the angular coefficient.

In many process systems, a typical system curve, FIG. 1, cannot be identified, but there the combination of required pressure head and volume flow is represented by different lines according to FIGS. 3-5. FIG. 3 shows a line for constant pressure head H, which basically originates from a series of underlying system curves, dashed in the figure. In a corresponding way, FIG. 4 shows curves for constant volume flow Q. FIG. 5 shows the typical system curve, and is in practice valid for regulation at a constant level, provided that the level regulating range is small relative to the pressure head of the system curve. For other control cases, e.g. temperature or concentration, as well as for non-Newtonian fluids (paper pulp suspensions), curve shapes deviating strongly from the above-mentioned are obtained. Accordingly, precise determinations of required power from Q-H-curves require extensive investigations. For a more detailed description of flow control with different types of regulation, reference is made to Pumphandboken, ISBN 91-86236-10-5, pages 163-181, or to its translation into English in British Pump Market, ISBN 0 907485 05 7, pages 5:1-5:19.

Rotodynamic machines have their instantaneous required power measured on their drive shaft almost exactly proportional to the third power of the machine rotation speed according to the so-called affinity laws. They apply to each individual performance point (Q, H and P), when a flow condition in the machine has equal facing angles for this point. The laws have a term n for a relative shaft rotation speed, wherein n=1 is a full rotation speed:
Volume flow Q is proportional to n.
Pressure head H is proportional to n².
Power measured on machine shaft P is proportional to n³.

The pressure head H is common in pumps. The corresponding applies to fans, if H is replaced by a pressure increase, and for compressors, by an enthalpy increase. In certain cases, it may be convenient to replace the volume flow with the mass flow constituting the product of volume flow and the density of the medium.

Deviations from the affinity law for power amounting up to one or a few percent of the power at full rotation speed are constituted of certain machine elements included in the machine, such as shaft bearings and shaft seals, the required powers of which, as a rule, are linearly dependent on the rotation speed. Accordingly, at a known rotation speed, an instantaneous required power can be determined relative to a relevant power at full rotation speed, “a full speed power”.

The invention is, inter alia, characterized in that, in a first stage, shaft rotation speed and required power at this rotation speed are measured for a rotodynamic machine having an already installed rotation speed control, and that, in a second stage, a power saving is calculated compared to the same machine provided with a fictitious, but conceivable, other type of regulation for the same system, when the machine operates at a constant rotation speed/“full rotation speed”,

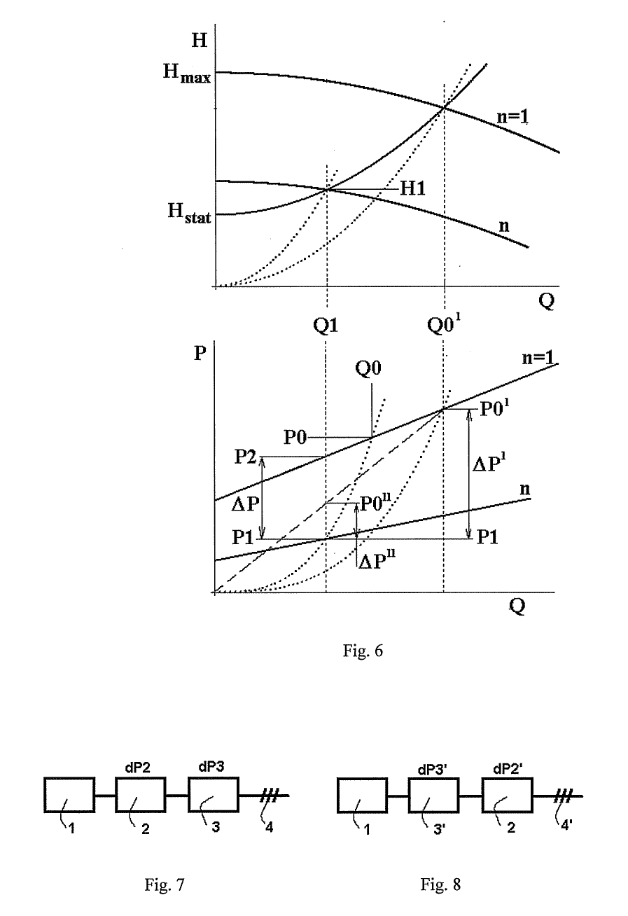

As an application, in an upper part FIG. 6 shows Q-H curves for a pump at 2 different rotation speeds; n and full rotation speed (n=1), and a system curve. A relative rotation speed is the ratio between the prevailing actual rotation speed and a full rotation speed, usually a maximum rotation speed. Dashed lines constitute 2nd order parabolas, based on the affinity laws, originating from the origin and passing through the system curve's intersections with the two pump curves. This upper curve portion is only shown for completeness, and is normally not needed when applying the invention, except in certain special cases. A lower part in FIG. 6 is a power diagram, showing power curves for two different rotation speeds. The dotted curves here constitute 3rd order parabolas originating from the origin and passing through points for the volume flow, which correspond to those valid for the Q-H diagram. The power saving achieved with rotation speed regulation is of course depending on which machine drive with constant rotation speed the comparison is made relative to.

In an imaginary throttle regulation, i.e. by throttling/changing pressure with a regulating valve connected in series with the machine, the volume flow is regulated to, for example, a value Q1 at a constant speed n=1 with the required power P2. During rotation speed regulation at the speed n with the same volume flow Q1, a required power P1, which is measurable on the machine shaft, is obtained. The instantaneous power saving ΔP as counted on the machine shaft amounts to P2-P1. The power P0 is determined from the affinity laws (or the same corrected for sealing and bearing friction), from the measured power P1.

P0=P1/n³ and Q1=n·Q0 [1]

In principle, in order to determine a correction P0-P2, a representative reference point Q_{ref}, P_{ref} on the power curve at full rotation speed has to be known, as well as the factor for the actual slope kₚ of the power curve. A simple proportioning yields:

P0=[Q0/Q_{ref}·(1−kₚ)+kₚ]·P_{ref} and [2a]

P2=[Q1/Q_{ref}·(1−kₚ)+kₚ]·P_{ref} [2b]

A combination of the equations 1 and 2 will now yield the power P2

P2=n·(P1/n³−kₚ·P_{ref})+kₚ·P_{ref} [3]

Since P_{ref} can be chosen freely in this case, kₚ·P_{ref} in FIG. 2 constitutes the ordinate in the origin=kₚ·Pₑₜₐₘₐₓ.

The saving related to the machine shaft is then obtained as:

ΔP=P2−P1 [4]

It is appreciated that similar relationships can be postulated for an imaginary valve regulation with a regulating valve connected in parallel with a machine, a so-called shunt regulation.

With the same desired volume flow Q1 and with an imaginary so-called overflow regulation, where the liquid which is not needed can flow over a brim and then be directed away or back to a suction source, slightly more complicated relationships are obtained. The volume flow at full rotation speed n=1 becomes Q0′ and the required power on the pump shaft P0′. Equation 2 is applied to the values Q0, P0, on the one hand, and to Q0′, P0′, on the other hand. After elimination of Q_{ref}, this yields:

Q0/Q0′=(P1−kₚ·P_{ref})/(P0′−kₚ·P_{ref}) [5]

For the unknown volume flow Q0′, the previous relationship for indirect measurement of volume flow is used, with the term SQRT[. . . ] for the square root:

Q1=Q0·n=SQRT [(n²−k_{H})/(1−k_{H})]·Q0′ [6]

If Q0/Q0′ is eliminated between equations 5 and 6, the sought-after power P0′ is obtained:

P0′=n·(P1/n³−kₚ·P_{ref})·SQRT [(1−k_{H})/(n²−k_{H})]+kₚ·P_{ref} [7]

The power saving will then become: ΔP′=P0′−P1.

For a fully unregulated volume flow, as is usually the case when circulating a medium, relationships analogous to overflow regulation apply. Powers are obtained from equations 6 and 7, if k_{H} is set equal to zero.

For the regulation of a machine driven at a constant rotation speed n=1 with on/off regulation (intermittent operation) it applies that, when the machine is in operation, it delivers a volume flow Q0′ and has a required power P0′, FIG. 6. When the machine is switched off, it naturally has the volume flow 0 and the required power 0. If the instantaneous requirement of volume flow is Q1, a relative operation time becomes=Q1/Q0′. An average power P0″ is then obtained according to equation 8a. In an installed rotation speed control with continuous operation, the flow is Q1 and the required power P1, FIG. 6. Compared to an imaginary on/off regulation, a rotation speed regulation brings about a power saving ΔP″, Equation 8b. The energy saving is obtained as the total time, of a given period, multiplied by the average energy saving ΔP″.

P0″=Q1/Q0′·P0′ [8a]

ΔP″=P0″−P1 [8b]

With Q0/Q0′ from Equation 6, and P0′ from Equation 7, the energy saving is determined in equation 8b. In FIG. 6, P0″ is generally represented by the dashed straight line from the origin to the point Q0′, P0′. For the volume flow Q1, P0″ and ΔP″ be read directly from the figure.

In those cases where the slope factor kₚ of the power curve can be regarded as small or 0, i.e. P2=P0=P_{ref}, or where the level and pressure difference in a system is 0 (Hₛₜₐₜ=0 and hence k_{H}=0, FIG. 1), the simple expressions according to equation 9 are obtained. An operating case where k_{H}=0 usually corresponds to a medium circulation.

P0=P1/n³ and ΔP=P0−P1 and P0′=P1/n³ ΔP=P0′−P1 resp. [9]

For a refined calculation of the influence of the shaft rotation speed, the bearing and seal friction's relative share of the power at full rotation speed is set to ΔL. The term n³ in equation 1, 3, 7 and 9 should then be replaced with (1−ΔL)·n³+ΔL·n, where ΔL is usually of the magnitude 0.01-0.03 with the largest values for smaller machines.

Equation 2a contains the 3 practically estimated but, from a mathematical point of view, unknown quantities Q0/Q_{ref}, P_{ref} and kₚ, where kₚ certainly can be estimated rather well from experience values. Provided that an operating condition of a machine varies somewhat over time when volume flow and rotation speed are concerned, the unknown values can gradually be refined through a moving adaptive method in that measured values for speed n and power P0(=P1/n³) are saved for at least 3 different measurement points and that an equation system based thereon is solved. Furthermore, the product kₚ·P_{ref} in Equation 3 can be determined directly at the flow Q1 and Q0 equal to zero. If the straight line has been replaced with a polynomial, as mentioned previously, coefficients in the polynomial can also be refined with a moving adaptive method.

In the general case, the adaptive method is advantageously based on selecting Q0′ and P0′, respectively, as Q_{ref}, P_{ref}. The coefficient kₚ will then assume a different value kₚ′. Equation 2 will then become:

P0/P0′=Q0/Q0′·(1−kₚ′)+kₚ′ [10]

For Q0/Q0′, the method for indirect measurement according to equation 6, which is inserted into equation 10, is used:

P0/P0′=1/n·SQRT[(1−n²)/(1−k_{H})]·(1−kₚ′)+kₚ′ [11]

In this equation, for one operating point, there are known values from measurement for n and P0=P1/n³. The quantities P0′, k_{H} and kₚ′ are to be considered as unknown. If k_{H} à priori is considered to be constant, 3 pairs of measurement values (n, P1) for 3 different operating points are sufficient. If Hₛₜₐₜ (FIG. 1) is varying, k_{H} is no longer constant. Then, more measurement points are used, so that a relationship for k_{H} as a function of both n and P0(=P1/n³) can be determined. The same relationship also applies to non-Newtonian fluids.

In case of large variations in the density of the medium and k_{H} deviating from zero, such as, for example, for thermal updraught in a chimney (chimney draught) enhanced by a flue gas fan, an additional refinement is obtained if the medium temperature is measured and the reference power P_{ref}, P0′ is adjusted accordingly in a way known per se.

The rotation speed of the machine shaft can be measured with several known methods, such as with a tachometer generator, with optical or inductive methods with indication from a black/white disc or from a grooved metal plate, respectively. For rotation speed regulation with a frequency changer, the rotation speed follows the frequency with a small deviation depending of the slip of the electric motor. When the frequency/voltage ratio (type F1) from the frequency changer is kept constant, the slip is proportional to the torque requirement of the machine and enables a corresponding correction of rotation speed. For machines with a so-called quadratic torque, to which rotodynamic machines on the whole belong, the voltage is sometimes lowered more than the frequency (type F2), so that the percentage slip becomes constant at all rotation speeds. Deviations from this are determined by the output power from the electric motor relative to its power rating, and by the slope of the machine's power curve, FIG. 2.

A rotodynamic machine 1 and a rotation speed control 3, 3′ can be differently arranged with respect to an electric motor 2, 2′, FIGS. 7 and 8. I FIG. 7, a rotation speed control can be constituted of a frequency changer 3 placed before the motor 2 and connected to an electricity supply system 4. In FIG. 8, a rotation speed control 3′ is, for example, a hydraulic clutch placed between the machine 1 and the motor 2′. The affinity laws for power apply to the machine 1, whereas the power most interesting from an economic point of view is the power supplied from the electricity supply system 4, 4′. The powers to/from the different components 1, 2, 2′, 3, 3′and 4, 4′ have to be corrected for power losses dP2, dP2′, dP3 and dP3′ in the respective components 2, 2′, 3 and 3′.

The measurement of the machine shaft power between the machine 1 and the motor 2, or between the machine 1 and the rotation speed control 3′, can take place directly by measuring torque in the shaft. The power is then obtained as torque times angular speed. The electric motor's input power, measured immediately before the motor 2, is measured indirectly, which power after reducing the power losses of the motor and the rotation speed control yields the shaft power. The input power to an electric motor 2, 2′ can be measured by the so-called 2 watt meter method or by measuring electrical current. The current measurement is very simple to perform, since only a current transformer, designed as a simple wire coiled around one of the connecting leads/phases of the electric motor, is needed. For power calculation (active power) a power factor (cosφ) must be known. This is specified in electric motor catalogues. The reactive power=the electric motor's power rating·tanφ is fairly constant at different active power outputs, since it depends on the magnetization of the electric motor. This relationship can advantageously be utilized for the power determination.

The same principle can be applied to an indirect measurement before a rotation speed control 3, for example designed as a frequency changer.

Power losses dP2, dP2′, dP3 and dP3′ are calculated in a way known per se and are used, on the one hand, for correction of (indirectly) measured power, if this is not done on the machine shaft and, on the other hand, for determining the required powers from electricity supply systems for the powers which have been determined, i.e. measured and/or calculated, to be valid for the machine shaft. For power, the affinity laws apply strictly to the machine shaft, while the costs are determined solely by the power from the grid 4, 4′. When some or all of the losses in the components (2, 2′, 3, 3′) are small, these two powers can replace each other without practical complications, in all conceivable and reasonable combinations.

The invention is further characterized in that measurements are repeated at least once for each studied period which forms the basis for a financial settlement. Advantageously, time intervals are based on statistical methods with, for example, about 30 measurements for each period. In the general case, measurement takes place with time intervals adapted to the nature of an actual process. Practically, these can vary from parts of a second in, for example, a rapid combustion process, to parts of a day in a sedimentation process. Advantageously, in the normal case, time intervals of the order of 10 seconds to 1 hour are chosen.

An apparatus according to the invention is characterized in input units for receiving measurable values during operation for the machine rotation speed and for directly or indirectly measurable power. Furthermore, there are input units for selection of an imaginary/fictitious type of other regulation, selection of parameters for the shape of the power curve, kₚ and P_{ref}, and for the hydraulic system parameter k_{H}, as well as for general information describing the specific characteristics of the machine, motor and rotation speed control. If the power curve is expressed by a non-rectilinear curve, coefficients describing it will be added to the input unit. The apparatus further has a timing unit indicating running time, a calculating unit, and a storing unit for the data from the input units, for time, and for calculated results. The results can be displayed directly in an output unit, alternatively be transferred by wire or wirelessly to a receiver. The units are interconnected in a way known per se, and are driven by some form of auxiliary power. Advantageously, a data processor programmed for the above-mentioned technique and based on electronic circuits is used.

Measurement must of course take place during operation, whereas calculations can take place both during operation as well as later. The calculation does not have to take place in the same local device (computer) but can, after transfer of time and measured values to a central computer, take place therein. The power for an imaginary/fictitious regulation method will then be valid for the same point in time as the measurement, in spite of the fact that the calculation does not take place simultaneously.

In its broadest sense, the invention can be varied within the stated principles. Accordingly, measurement/determination of power can take place indirectly with a somewhat lower accuracy from Q-H-curves, upper part of FIG. 6, in that at least two of the three quantities Q1, H1 and n are measured, wherein H1 is the pressure head at the flow rate Q1. Measurement values can advantageously be taken from the measuring devices used for a process control. The power P1 is then obtained from a known Q-H curve and a known Q-P curve at the full rotation speed n=1, according to the principles stated herein.

1-11. (canceled)

12. A method for determining the power saving of a rotodynamic machine, said rotodynamic machine being provided with a rotation speed control for forwarding/processing a medium and usually driven by an electric motor, relative to the power required by the same machine driven at a constant rotation speed or nearly constant rotation speed and with the forwarding/processing controllable in an imaginary/fictitious way by another type of regulation, said rotodynamic machine having a required power during operation in dependence upon a rotation speed (n) controllable in dependence upon an external varying quantity, said method comprising:
measuring the rotation speed (n) on the machine shaft at a given point in time;
determining a first power (P1) on the machine shaft, or a first power quantity depending on this power including certain associated power losses (P1+dP2, P1+dP2+dP3, P1+dP3′, P1+dP3′+dP2′);
determining, with guidance from the machine power curve's dependence on rotation speed, a power (P0) at a corresponding flow rate (Q0) with the affinity laws and advantageously also the power curve's dependence on a volume flow, a second power “full speed power” (P2, P0′, P0″) or a second power quantity depending on this power including certain associated power losses is calculated instantaneously during operation or at a later point in time;
determining the difference between said second power (P2, P0′, P0″) and said second power quantity, respectively, and said first power (P1) and first power quantity, respectively, said difference constituting a measure of the power saving, which between the second and the first power constitutes ΔP, ΔP′ and ΔP″, respectively, and the corresponding between said two power quantities and then including certain power losses; and
repeating the measurement at such intervals, that the variation of the saving becomes representative with time, wherein the saving can form a basis for financial settlements.

13. The method according to claim 12, wherein the first power quantity is determined by measuring power together with the rotation speed (n) measured on the machine shaft or at the motor or at the rotation speed control.

14. The method according to claim 12, wherein the first power quantity is determined by measuring the volume flow/mass flow of the machine together with the measured speed (n) and by calculating/reading from basic curve data related to the machine.

15. The method according to claim 12, wherein the first power quantity is determined by measuring the pressure head/pressure increase/enthalpy increase of the machine together with the measured speed (n) and by calculating/reading from basic curve data related to the machine.

16. The method according to claim 12, wherein, for refining the influence of affinity laws for rotodynamic machines on measurement accuracy for power and power saving, the influence on power in calculations is divided into a larger part, following the third-power relationship of the affinity laws for rotation speed, and a smaller power part (a few percent), primarily related to bearing and shaft seals in the machine, depending substantially proportionally on the rotation speed.

17. The method according to claim 12, wherein, for refining the power determination from the affinity laws applying to a machine shaft and for increasing measurement accuracy for the power saving, the previously mentioned determined values for power losses arising in the rotation speed control dP3, dP3′ and in the electric motor dP2, dP2′ are adjusted, wherein power losses are calculated in a way known per se.

18. The method according to claim 17, wherein the per se known or estimated quantities kₚ, k_{H}, P_{ref}, P0′, Q0/Q_{ref}, Q0/Q0′, ΔL, as well as, where appropriate, coefficients for an adapted curve expressing the power on the machine shaft at a constant rotation speed as function of the volume flow Q, are continuously refined by means of a moving adaptive method in that measured values for rotation speed (n) and power P0, P0′ are saved for a sufficient number of different operating points for calculation by solving equation systems based thereon for obtaining updated values for these quantities from time to time.

19. The method according to claim 17, wherein the per se known or estimated quantities kₚ, k_{H}, P_{ref}, P0′, Qₒ/Q_{ref}, Q0/Q0′, ΔL, as well as, where appropriate, coefficients for a polynomial adapted curve expressing the power on the machine shaft at a constant rotation speed as function of the volume flow Q, are continuously refined by means of a moving adaptive method in that measured values for rotation speed (n) and power P0, P0′ are saved for a sufficient number of different operating points for calculation by solving equation systems based thereon for obtaining updated values for these quantities from time to time.

20. The method according to claim 12, wherein an energy saving is determined as the integral of the power saving with respect to time over a given period.

21. The method according to claim 12, wherein the efficiency of the machine is determined continuously by a thermodynamic method known per se, wherein the efficiency constitutes a control factor for the determined power saving, and at the same time can be used for evaluating the condition of the machine.

22. The method according to claim 12, wherein information, in and for financial transactions, for example charging/invoicing, about the energy saving and possibly also an energy consumption, and possibly also an efficiency, is transferred by wire or wireless technique, via an electricity supply system, a telecommunication network, or a corresponding system.

23. An apparatus for determining power saving of a rotodynamic machine provided with a rotation speed control and usually driven by an electric motor, said machine having a required power during operation in dependence upon a variable rotation speed (n) controllable in dependence upon an external, usually varying quantity, wherein the power saving is relative to a required power for the same machine driven at a constant rotation speed and is controllable by an imaginary/fictitious method of another type, wherein the apparatus comprises:
a first input unit being adapted to, during operation, receive a measurable actual speed (n) and a measurable power on the machine shaft P1 or a quantity P1+dP2, P1+dP2+dP3, P1+dP3′+dP2′ depending on this power;
a second input unit for receiving the parameters describing the system which are typical for the method mentioned herein;
a timing unit indicating time;
a calculating unit; and
a storing unit for the running values from the input units and for calculated results, which by means of an output unit are readable or transmittable to a receiver, wherein certain parts of the calculations can be performed by equipment connected to the receiver.
